(19) United States
(12) Patent Application Publication
(10) Pub. No.: US 2025/0074136 A1
(43) Pub. Date: Mar. 6, 2025

(54) Device, Vehicle, and Heat Management Method for a Streaming Box

(71) Applicant: Bayerische Motoren Werke Aktiengesellschaft, Muenchen (DE)

(72) Inventor: Bertram HOCK, Kirchdorf (DE)

(21) Appl. No.: 18/726,351

(22) PCT Filed: Nov. 15, 2022
(86) PCT No.: PCT/DE2022/100852

§ 371 Date: Jul. 2, 2024

(30) Foreign Application Priority Data
Jan. 4, 2022 (DE) 10 2022 100 135.0

(51) Int. Cl. B60H 1/00

(52) U.S. Cl. CPC B60H 1/00271; B60H 2001/003

(57) ABSTRACT

A heat management method for an external user terminal of an electronic entertainment system for streaming multimedia content (streaming box) in a vehicle, includes ascertaining an electric signal by the vehicle, ascertaining a heat discharge or a heat supply requirement of the streaming box on the basis of the electric signal and a defined reference, and in response thereto, automatically actuating an air pump and/or a heating and air conditioning device of the vehicle.

### BACKGROUND AND SUMMARY

The present disclosure relates to a device, a vehicle and a heat management method for an external user terminal of an entertainment electronics system for streaming multimedia content (streaming box) in a vehicle. The present disclosure particularly relates to a way of integrating an entertainment electronics system for video streaming (Google Chrome Cast, Apple TV, Amazon Fire TV (Stick)) in a manner suitable for use in the automotive sector.

In the prior art, the vehicle electronics system, in particular the multimedia capability of vehicle, represents an increasingly more critical competitive advantage for vehicle manufacturers. However, the comparatively long development cycles of a new vehicle model can no longer keep pace with the development cycles in the field of entertainment electronics (bandwidths, processor performance, image resolutions, rendering, connectivity, etc.). Accordingly, the multimedia capabilities of new vehicles are sometimes comparatively old compared to the solutions available for home entertainment. This problem is exacerbated by the longer life cycles of a vehicle compared to entertainment electronics devices for the living room at home. In particular, retrofitting the latest hardware and software in a vehicle is usually not economically viable.

In contrast, the streaming boxes developed for the living room at home are neither developed nor suitable for use in q vehicle. In particular, large changes in temperature and, at times, moisture are not compatible with durability and operational capability of streaming boxes in a vehicle. In addition, some streaming boxes are provided with internal power supply units and are therefore largely unsuitable for operation in an on-board electrical system that usually operates on 12 V.

One object of the present disclosure is to meet the requirement identified above and, in particular, to enable streaming boxes to be used in a vehicle.

According to the present disclosure, the object mentioned above is achieved by a heat management method for an external user terminal of an entertainment electronics system for streaming multimedia content (streaming box) in a vehicle. Within the scope of the present disclosure, “heat management” can be considered ensuring suitable climate conditions for accommodating and operating streaming boxes on board a vehicle (e.g. a passenger car, transporter, truck, aircraft and/or watercraft). Particular mention should be made here of the temperature and the atmospheric moisture. The streaming box may be understood to mean, for example, a stand-alone device with its own power plug or USB connection, HDMI output (HDMI socket), its own housing and possibly its own fan/its own ventilation slots. In order to ensure suitable thermal boundary conditions for the streaming box, an electrical signal is ascertained by the vehicle in a first step. For example, electrical energy consumption by the streaming box and/or a temperature sensor signal can be picked up by the vehicle and/or an acceleration signal and/or an acoustic signal from the streaming box can be picked up by a sensor system of the vehicle for this purpose. A heat discharge or heat supply requirement of the streaming box can then be ascertained on the basis of the electrical signal. For example, the temperature of the streaming box or a housing of the vehicle surrounding the streaming box can be directly determined by a temperature sensor signal. A heat discharge requirement can be inferred from electrical energy consumption by the streaming box for example based on a (high) processor performance and/or based on operation of a fan inside the streaming box. The operation of a fan of the streaming box can be inferred from an acoustic signal and/or an acceleration signal (in particular periodic alternating signals) and therefore indicate the heat discharge requirement of the streaming box. Alternatively, a light sensor, for example, can also render a very high level of solar radiation into the passenger compartment of a vehicle identifiable and/or a current driving performance can identify waste heat in the engine compartment and/or in a battery pack of the vehicle, this having an effect on external heating of the streaming box (with a time delay and/or indirectly). In response to the heat discharge or heat supply requirement being identified, an air pump and/or a heating/air-conditioning device of the vehicle can then be automatically actuated in order to supply heat to or draw heat from the streaming box. The heat discharge and/or heat supply requirement can therefore be ascertained, in particular, independently of a setting for a target temperature for certain regions of the vehicle (e.g. defined by a user). Therefore, operation of the streaming box can be assisted or ensured, even though the streaming box is not developed for use in the automotive sector and may be installed in a comparatively disadvantageous location within the vehicle.

The present disclosure includes preferred developments.

The heat discharge and/or heat supply requirement of the streaming box can be ascertained depending on an interior temperature of the vehicle. For example, it is possible to ascertain that the air temperature in the passenger compartment is (currently) not suitable for compensating for the current heat output or imminent heat output of the streaming box. In other words, a temperature sensor of the vehicle can therefore be used for generating the electrical signal which measures an air temperature and/or a surface temperature of the streaming box. A predefined reference (e.g. a data set and/or a mathematical function) can be defined here for ascertaining the heat discharge and/or heat supply requirement. In response to the heat discharge and/or heat supply requirement being ascertained, the heating/air-conditioning device can be actuated in order to adjust an air temperature within the vehicle. For example, the air temperature in that volume in which the streaming box is located can be adjusted by the heating/air-conditioning device of the vehicle. This volume may be present, for example, inside a housing of an electronic control unit of the vehicle and/or in some other cavity in the vehicle interior. In particular, cavities of this kind in the vehicle can accommodate the streaming box and are configured to be inaccessible (directly or without use of a tool) by the user/occupant. The temperature sensor, which is used to generate the electrical signal of the vehicle, can therefore be located in a volume in which no temperature measurement is usually (in the prior art) required. The air temperature can be adjusted by such an air flow which delivers heat or cold from a heating/air-conditioning device past a volume in which the streaming box is located, or, passing along the streaming box, into the interior. It is therefore possible to ensure that enough heat is drawn from/passed to the streaming box.

During the course of adjusting the air temperature or actuating the air pump of the vehicle in response to ascertaining the heat discharge and/or heat supply requirement, a setting for the heating/air-conditioning device that does not correspond to the target conditions within the passenger compartment or prevents the target provisions may be required. Therefore, provision may preferably made for the changed mode of operation of the air pump and/or the heating/air-conditioning device to be compensated for by actuating another control unit or another component of the heating/air-conditioning device. Compensation can be performed one by one or completely. For example, an air flow temperature reduced for additionally drawing heat from the streaming box may be raised again in a duct of the heating/air-conditioning device by subsequent heating (after passing the streaming box) (e.g. by electrical heating wires) to a temperature that leads to the target temperature being established in the passenger compartment. In other words, the same air flow that then enters the interior having been electrically heated is first used to cool the streaming box. In particular, the waste heat output of the streaming box can be taken into consideration by computer, in particular in a model-based manner, when the component/the heating elements is/are actuated for compensating for the changed mode of operation of the air pump. In terms of control, this can be performed as follows: the air temperature of the heating/air-conditioning installation is initially lowered (e.g. by an air-conditioning compressor) to such an extent that a sufficient amount of heat is drawn from the streaming box. The electrical heating device situated downstream is then actuated such that the ascertained waste heat output of the streaming box in conjunction with the electrical heat output of the heating device raises the air flow temperature in such a way that the target interior temperature in the vehicle is reached.

The streaming box can itself have a housing, a processor, a memory, a communications module, a power plug or USB connection and/or a monitor/audio/video output cable. Here, the interfaces of the streaming box are configured in particular in accordance with the currently customary interfaces for home entertainment electronics. For example, a 230 V plug and/or a USB connection for the power supply and/or the data input and/or a WLAN module and/or an LAN socket and/or an HDMI connection can be provided and connected to the on-board electrical system of the vehicle. In other words, the streaming box can be configured for operation within the vehicle in the manner of a plug-and-play connection in order to not forfeit complicated cabling and any warranty claims against the manufacturer of the streaming box. Nevertheless, a temperature sensor and/or an infrared sensor can be secured (e.g. adhesively bonded or prestressed) on the housing of the streaming box in order to be able to tap off temperature signals from the housing. The same applies to an acceleration sensor and/or a microphone for ascertaining a state of operation of the streaming box. The housing of the streaming box in turn can be accommodated in a housing of an electronic control unit of the vehicle. This housing may be a 1 DIN box which is arranged in a corresponding pocket. A USB cable and/or a 230 V plug socket and/or an HDMI cable and/or an LAN cable and/or audio cable for connecting the streaming box to the entertainment system and to the further on-board electrical system of the vehicle may be provided within this 1 DIN box for incorporating the streaming box into the on-board vehicle electrical system. The streaming box and the abovementioned 1 DIN box can be arranged, for example, in a center console and/or in a rear-seat entertainment control unit or pocket. In this way, the streaming box is arranged in a housing (this not meaning the passenger compartment of the vehicle itself) which is arranged in the interior, that is to say for example in a dashboard or below a compartment in the center console of the vehicle. Suitable heat discharge and/or heat supply is ensured in this way, as are crash-proof and tidy accommodation of the streaming box.

A user operating action for influencing the functioning of the air pump and/or the heating/air-conditioning device of the vehicle can preferably also be ascertained. The purpose of the user operating action may be, for example, to reduce an air flow rate, in particular to switch off a fan or the entire heating/air-conditioning device. Based on the ascertained heat discharge or heat supply requirement of the streaming box, the air pump and/or the heating/air-conditioning device of the vehicle is, however, consequently actuated in a changed way than would be customary according to the prior art (according to which the reduction or switch off would be performed in accordance with a user request). This has the background that the use according to the present disclosure of the air flow for controlling the climate of the passenger compartment of the vehicle is additionally used for heat supply to/heat discharge from the streaming box and as a result, at times, there is a continuous requirement for an air-conditioned/heated air flow. The air flow is therefore maintained (in a manner at least virtually imperceptibly to the user), but in particular reduced in comparison to a previous flow rate. Therefore, the user request can be satisfied at least for the most part and nevertheless continued operation of the streaming box can be ensured.

In particular—as already discussed further above—an attempt can be made to at least partially compensate for the continued operation of the fan. For example, the air flow can be deflected in the direction of the interior in such a way that direct sensory perception by the user is precluded as well as possible. For example, air vents located in the footwell of the vehicle or air vents placed in the region of a row of rear seats (e.g. third row of seats) can be used for dissipating the air guided along the streaming box, without the user being able to feel a draft. For this purpose, air vents designed in principle for air to flow at the head and/or upper body of the user for example can be automatically closed or automatically directed in another direction.

Therefore, while the user demands modification of the function of the air pump or the heating/air-conditioning system of the vehicle to a specific value or in a specific mode, adjustment to a second value, which is different from the first value, or mode is performed and may be (partially) compensated for in respect of the user experience based on the ascertained heat discharge and/or heat supply requirement of the streaming box. On the contrary, the first value (the user's desired value or mode) can be communicated to the user themselves via a user interface as a new target setting in order to not give the user the impression that the system has malfunctioned. For example, the fan or the heating/air-conditioning installation of the vehicle can continue to be operated unnoticed by the user (secretly) based on a requirement of the streaming box, even though the user has selected a different state of operation.

A second aspect of the present disclosure proposes a heat management device for an external user terminal of the entertainment electronics system for streaming multimedia content (streaming box) in a vehicle. The device comprises a data input, an evaluation unit and a data output. The device can further have a housing within which the streaming box (together with its own housing) is arranged. The data input can be designed to ascertain the abovementioned electrical signal representing a heat discharge and/or heat supply requirement of the streaming box. The evaluation unit can ascertain, in consideration of further information, the way in which continued operation of the streaming box can be ensured as well as possible. For this purpose, target temperature values, actual temperature values and other settings of a heating/air-conditioning system of the vehicle can be ascertained and suitable signals for actuating the fans and the heating/air-conditioning device of the vehicle can be output via the data output. In this way, the device according to the present disclosure can clearly correspondingly implement the features, combinations of features and the resulting features in such a way that reference is made to the above statements in order to avoid repetition.

A third aspect of the present disclosure proposes a vehicle which has a device according to the second-mentioned aspect of the present disclosure. In this way, the features, combinations of features and advantages mentioned in conjunction with the device can also be achieved for the vehicle according to the present disclosure.

Further aspects without a restrictive character are disclosed below as being advantageous for implementing a device according to the present disclosure, a vehicle according to the present disclosure and a method according to the present disclosure. According to the present disclosure, the streaming box can be placed into a cavity which is closed, for example, by a plastic lid (e.g. composed of PA66 or ABS). The streaming box can have direct access to the Internet without communication with the on-board vehicle electrical system, so that data security-related safety is ensured at any time. Universal fastening options, by way of which the housing of the streaming box can be fastened, can be provided within the 1 DIN box or within the electronic control unit. By way of example, elastic bands, clasps which can be screwed in different positions or other elastic elements for grating-and/or vibration-free connection of the streaming box can be provided for this purpose. Moreover, it is possible to also accommodate the streaming box at a different location by using an HDMI cable. Cables of the streaming box can be mechanically secured firstly to the housing of the streaming box and as an alternative or in addition to corresponding interfaces of the on-board electrical system of the vehicle in such a way that accidental disconnection of the cables is effectively prevented. For example, additional buckles, clasps or other locking device can prevent accidental release of the connection which otherwise meets the known standards for home entertainment electronics. The housing of the streaming box can be connected to a housing of the vehicle, this housing surrounding the housing of the streaming box, in such a way that heat conduction from the housing of the vehicle is ensured and the air volume within the housing of the vehicle is not unnecessarily performed. In this way, heat can be discharged in a more efficient and possibly predominantly passive manner. The fan or the air-conditioning/heating device of the vehicle can therefore also be active outside the housing of the vehicle and discharge the heat from the streaming box initially discharged by solid-state technology by convection or forced convection at another location. In particular, bus communication can be provided for operating the streaming box only with read rights. In other words, programming via the used bus can be precluded. Instead, diagnosis and coding can be performed via a proprietary interface (e.g. LIN) to a host control unit, with the control unit functioning as a slave. The streaming box cannot write into the vehicle system. A cyber-attack (e.g. via IP access) is prevented in this way. A Bluetooth channel can, as a “mobile device” (that is to say like a telephone), connect to the head unit of the vehicle in order to be able to transmit audio from the streaming box into the entertainment system of the vehicle. The device according to the present disclosure can transmit infrared signals from the passenger compartment to the housing (a corresponding interface) of the streaming box. For this purpose, an infrared receiver in the passenger compartment can receive signals from a remote control arrangement and the infrared signals (containing converted information) can be passed via the line to the streaming box. Here, the signals (still in the form of an electrical signal or once again converted into the infrared range) can be received and interpreted by the streaming box. A Bluetooth connection from the entertainment system of the vehicle in the direction of the streaming box allows the user to operate the streaming box by way of the hardware interfaces. For example, rotary/pushbutton actuator signals of the vehicle can be translated and in this form sent to the streaming box as if a remote control arrangement had been operated. For example, the control unit for the rear-seat entertainment arrangement can be connected to the streaming box via WLAN.

Further details, features and advantages of the present disclosure can be found in the following description and the figures.

### BRIEF DESCRIPTION OF THE DRAWINGS

FIG. 1 shows a schematic scene within a vehicle, in which an exemplary embodiment of a method according to the present disclosure is executed;

FIG. 2 shows a view of a detail of components of an exemplary embodiment of a device according to the present disclosure; and

FIG. 3 shows a flowchart illustrating the steps of an exemplary embodiment of a heat management method according to the present disclosure for a streaming box.

### DETAILED DESCRIPTION OF THE DRAWINGS

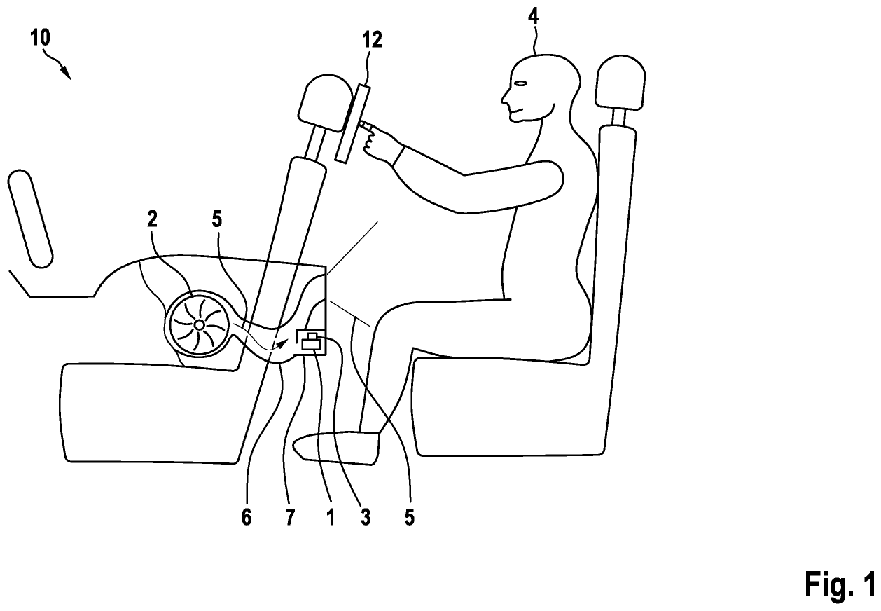

FIG. 1 shows a user 4 inside a passenger car as an example vehicle 10 according to various embodiments of the present disclosure, the user making entries via a screen 12 of a rear-seat entertainment system. The user 4 can influence the target temperature of a heating/air-conditioning system and the functioning of a streaming box 1 via the screen 12. The streaming box 1 is arranged in a housing 7 within a center console of the vehicle 10. The housing 7 is in turn provided with a temperature sensor 3, so that the vehicle 10 receives information about the heat discharge/heat supply requirement of the streaming box 1. The housing 7 is partially open with respect to an air-conditioning duct 6, so that an air flow 5 forced by an air pump 2 initially flows along the open housing 7 and is then spread into the vehicle interior.

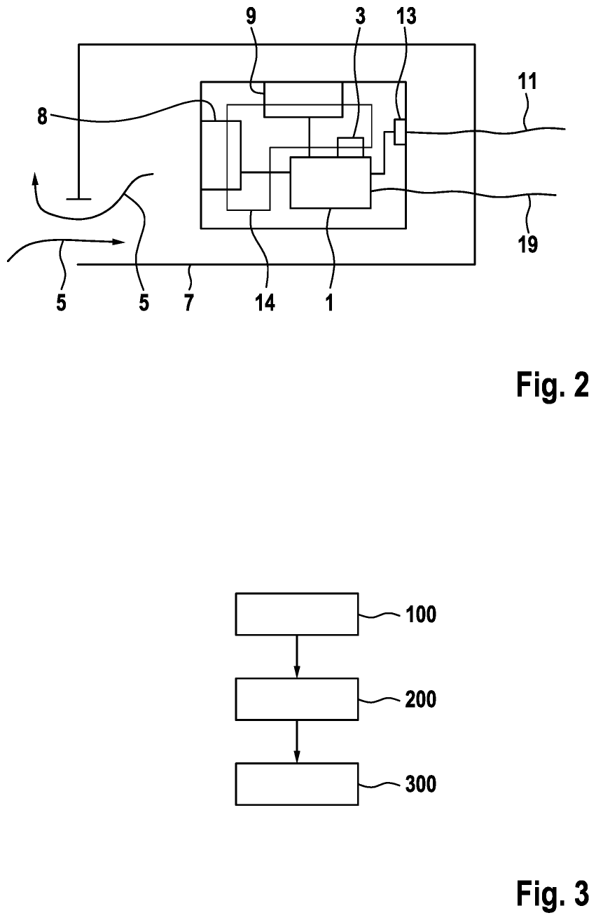

FIG. 2 shows a view of a detail of the housing 7 from which heat is drawn or which is heated by a portion of the air flow 5. An electronic control unit 14 with a data input 8 and a data output 9, which are also connected to a streaming box 1, is located in the housing 7. The streaming box 1 is energetically connected to the on-board electrical system 11 of the vehicle, for example via USB connection 13. An interface of the streaming box 1 (e.g. a USB connection) is additionally linked to the peripheral equipment via a data line 19. The vehicle can make a decision about a heat discharge and/or heat supply requirement of the streaming box 1 both via the temperature sensor 3 and also via the energy consumption by the streaming box 1 and accordingly adjust a temperature and a flow rate of the air flow 5.

FIG. 3 shows steps of an exemplary embodiment of a heat management method according to the present disclosure for a streaming box 1 in a cavity of a vehicle. In step 100, an electrical signal is ascertained by the vehicle, which signal ascertains an electrical energy consumption characteristic of the device (e.g. current and/or voltage consumption with periodic fluctuations on account of a rotating fan). A heat discharge and/or heat supply requirement of the streaming box is ascertained in step 200 on the basis of the electrical signal and a predefined reference. In order to satisfy this requirement, in step 300, an air pump of a heating/air-conditioning device of the vehicle is automatically actuated in response to the requirement being ascertained, in order to increase the air flow around the streaming box 1 and thus to accelerate the heat discharge.

### LIST OF REFERENCE SIGNS

1 Streaming box
2 Air pump
3 Temperature sensor
4 User
5 Air flow
6 Air-conditioning duct
7 Housing
8 Data input
9 Data output
10 Vehicle
11 On-board electrical system
12 Screen
13 USB connection
14 Electronic control unit
19 Data line
100 to 300 Method steps

1-12. (canceled)

13. A heat management method for an external user terminal of an entertainment electronics system for streaming multimedia content in a vehicle (“streaming box”), the method comprising:
ascertaining an electrical signal by the vehicle;
ascertaining a heat discharge or heat supply requirement of the streaming box on a basis of the electrical signal and a predefined reference; and
automatically actuating an air pump and/or a heating/air-conditioning device of the vehicle in response to ascertaining the heat discharge or heat supply requirement.

14. The method according to claim 13, comprising:
in response to ascertaining the heat discharge or heat supply requirement, ascertaining an interior temperature of the vehicle; and
actuating the heating/air-conditioning device to adjust the interior temperature.

15. The method according to claim 13, comprising:
compensating for a changed mode of operation of the air pump by actuating a valve of the vehicle.

16. The method according to claim 13, wherein the streaming box comprises a housing and a power supply unit in the housing, wherein the power supply unit is connected to electrics of on-board electrical system.

17. The method according to claim 13, wherein the electrical signal represents energy consumption by the streaming box and/or a signal from an acceleration sensor on the streaming box.

18. The method according to claim 13, comprising:
executing a temperature measurement by at least one temperature sensor of the vehicle for generating the electrical signal.

19. The method according to claim 13, wherein the streaming box is arranged in a housing of the vehicle.

20. The method according to claim 13, comprising:
ascertaining a user operating action for influencing functioning of the air pump and/or the heating/air-conditioning device of the vehicle; and,
based on the ascertained heat discharge or heat supply requirement, actuating the air pump and/or the heating/air-conditioning device of the vehicle in a manner that is different than would be the case in the absence of the ascertained heat discharge or heat supply requirement.

21. The method according to claim 13, comprising:
ascertaining a user operating action for adjusting an air flow of the heating/air-conditioning system of the vehicle to a first value; and
based on the ascertained heat discharge or heat supply requirement of the streaming box, alter the air flow to a second value, which is greater than the first value.

22. The method according to claim 21, comprising:
outputting an output, which represents the first value, to the user.

23. A heat management device for an external user terminal of an entertainment electronics system for streaming multimedia content (“streaming box”) in a vehicle, the heat management device comprising:
a data input;
a processor; and
a data output,
wherein the heat management device is configured to:
ascertain an electrical signal via the data input;
ascertain a heat discharge or heat supply requirement of the streaming box on a basis of the electrical signal and depending on a predefined reference by the processor; and
actuate an air pump and/or a heating/air-conditioning device of the vehicle via the data output.

24. The heat management device according to claim 23, configured to:
in response to ascertaining the heat discharge or heat supply requirement, ascertain an interior temperature of the vehicle; and
actuate the heating/air-conditioning device to adjust the interior temperature.

25. The heat management device according to claim 23, configured to:
compensate for a changed mode of operation of the air pump by actuating a valve of the vehicle.

26. The heat management device according to claim 23, wherein the streaming box comprises a housing and a power supply unit in the housing, wherein the power supply unit is connected to electrics of on-board electrical system.

27. The heat management device according to claim 23, wherein the electrical signal represents energy consumption by the streaming box and/or a signal from an acceleration sensor on the streaming box.

28. The heat management device according to claim 23, configured to:
execute a temperature measurement by at least one temperature sensor of the vehicle for generating the electrical signal.

29. The heat management device according to claim 23, wherein the streaming box is arranged in a housing of the vehicle.

30. The heat management device according to claim 23, configured to:
ascertain a user operating action for influencing functioning of the air pump and/or the heating/air-conditioning device of the vehicle; and,
based on the ascertained heat discharge or heat supply requirement, actuate the air pump and/or the heating/air-conditioning device of the vehicle in a manner that is different than would be the case in the absence of the ascertained heat discharge or heat supply requirement.

31. The heat management device according to claim 23, configured to:
ascertain a user operating action for adjusting an air flow of the heating/air-conditioning system of the vehicle to a first value; and
based on the ascertained heat discharge or heat supply requirement of the streaming box, alter the air flow to a second value, which is greater than the first value.

32. The heat management device according to claim 31, configured to:
output an output, which represents the first value, to the user.
